(19) United States
(12) Patent Application Publication
(10) Pub. No.: US 2012/0101712 A1
(43) Pub. Date: Apr. 26, 2012

(54) METHOD FOR ASSESSING DRIVER ATTENTIVENESS

(75) Inventors: Thomas Schramm, Mainz (DE); Ralf Rathmacher, Schmitten im Taunus (DE); Michael Schiebahn, Wesseling (DE)

(73) Assignee: GM GLOBAL TECHNOLOGY OPERATIONS LLC, Detroit, MI (US)

(21) Appl. No.: 13/278,262

(22) Filed: Oct. 21, 2011

(30) Foreign Application Priority Data
Oct. 21, 2010 (DE) 10 2010 049 087.3

(51) Int. Cl. G06F 17/00

(52) U.S. Cl. 701/300

(57) ABSTRACT

The attentiveness of the driver of motor vehicle traveling in a lane provided with boundaries on both sides is assessed by measuring the distance of the vehicle from one of the boundaries, determining the objective lateral freedom of movement of the vehicle in the lane, specifying a desired range of the distance of the vehicle from one boundary by means of the objective lateral freedom of movement, and adapting a parameter representative of the assessed attentiveness of the driver when the distance of the vehicle from one boundary leaves the desired range.

### CROSS-REFERENCE TO RELATED APPLICATION

This application claims priority to German Patent Application No. 102010049087.3, filed Oct. 21, 2010, which is incorporated herein by reference in its entirety.

### TECHNICAL FIELD

The technical field relates to a method and apparatus for assessing the attentiveness of the driver of a traveling motor vehicle.

### BACKGROUND

Apparatuses and methods are known for monitoring the driving activities of the driver of a motor vehicle in order to assess their quality and by means of the assessment to estimate the level of attentiveness of the driver and if necessary generate a warning. Known from WO 2006/108372 A1 is a driver assistance system which uses an optical lane monitoring system to determine the distance of the vehicle from a lateral boundary of a lane being driven upon. Various speed-dependent limiting values of the distance are selected depending on the width of the lane and if it is determined that the vehicle goes below the limiting value of the distance valid in each case, a warning signal is generated in order to warn of an impending departure of the vehicle from the lane.

A disadvantage of this known system is that it does not take account of the fact that a departure of the vehicle from the lane must be avoided in both directions, to the left and to the right. The vehicle is generally narrower than the lane in which it is moving and the difference between the width of the lane and that of the vehicle is the maximum amount by which the lateral position of the vehicle on the lane can fluctuate without the vehicle departing from the lane. This difference is designated hereinafter as objective lateral freedom of movement. It is all the smaller, the wider the vehicle. If the known method is applied for monitoring the distance of the vehicle from both sides of the lane, a subjective lateral freedom of movement of the vehicle is thereby determined, i.e., an extent within which the position of the vehicle in the transverse direction of the lane can fluctuate without the assistance system responding. This subjective lateral freedom of movement is smaller than the objective lateral freedom of movement by the limiting values determined in each case for the left and the right side of the lane. Limiting values of the distance which ensure a convenient-to-handle subjective lateral freedom of movement for a small car can allow such a small subjective lateral freedom of movement for a wide vehicle that even a highly focused driver cannot avoid the assistance system responding or can even lead to a complete disappearance of the subjective lateral freedom of movement.

As a result of the speed dependence of the limiting values, in the conventional system in particular the situation can occur that a wide vehicle can still travel at lower speed without triggering the response of the assistance system whereas at increased speed the subjective lateral freedom of movement is zero and it is no longer possible to drive without the assistance system responding. Conversely, a system adapted for a wide vehicle, when used on a narrow vehicle, allows the driver such a large lateral freedom of movement that a reduction in the driver's ability to concentrate is only detected very late and possibly too late. In order to be able to use the conventional driver assistance system on vehicles of different width, a complex adaptation of the speed-dependent distance limiting values is therefore required each time.

It is at least one object to provide a method or a driver assistance system for assessing the attentiveness of the driver, which can be applied to vehicles having different widths without adaptation or with minimal adaptation effort. In addition, other objects, desirable features and characteristics will become apparent from the subsequent summary and detailed description, and the appended claims, taken in conjunction with the accompanying drawings and this background.

### SUMMARY

A method is provided that comprises the steps of measuring the distance of the vehicle from one of the boundaries of the lane, determining the objective lateral freedom of movement of the vehicle in the lane, specifying a desired range of the distance of the vehicle from one boundary by means of the objective lateral freedom of movement, and adapting a parameter representative of the assessed attentiveness of the driver when the distance of the vehicle from one boundary leaves the desired range.

The width of the desired range is preferably a fraction of the objective lateral freedom of movement, which depends on the speed of the vehicle. Depending on how means available for measuring the distance are constituted, it can be expedient that step b) comprises measuring the distance of the vehicle from the other boundary and determining the objective lateral freedom of movement by means of the sum of the measured distances or that the distance between the two boundaries is measured directly and the objective lateral freedom of movement is determined by means of the difference between the measured distance and the width of the motor vehicle. In the former case, the method can be applied to vehicles of different width without any adaptation, in the latter case; the width is the only parameter which possibly needs to be varied to adapt the method to a given type of vehicle.

The step b) of determining the objective lateral freedom of movement is repeated periodically in order to be able to identify changes in the width of the lane being driven upon. If a change in the objective lateral freedom of movement is detected, it is expedient to suspend the execution of step d) in order to give the driver, in particular after a lane narrowing on one side, the opportunity to correctly align his vehicle on the lane.

Therefore, the width of the lane is not the criterion for specifying a distance from the lane boundary which should not be fallen below but the objective lateral freedom of movement, with the result that allowance for various possible widths of different vehicle types is automatically obtained.

The aforementioned parameter is preferably a numerical value, whose deviation from a standard value is increased in each case in step d). A warning is expediently generated when this deviation exceeds a limiting value. The provides the possibility for ignoring isolated events in which the distance of the vehicle from the boundary leaves the desired range and only generate the warning signal when there is an accumulation of such events. On the one hand, such an intentional departure from the desired range, for example, when changing lanes or turning, generally does not result in the triggering of a warning signal, on the other hand, this measure allows the desired range to be specified so narrowly that if the attentiveness of the driver has actually diminished and the warning signal needs to be generated, this can already take place at a large distance from the lane boundary so that the driver has sufficient time for a steering correction.

Even with an attentive driver, it can arise from time to time that the desired range is departed from, for example, if it is necessary to avoid other traffic. In order that such events do not trigger a warning signal after driving for some time, it is expedient to decrease the deviation of the numerical value from the standard value when a predefined time span has elapsed since the last decrease of the deviation or since its last increase.

A driver assistance system comprises an measuring device for measuring the distance of the vehicle from at least one of the boundaries of the lane being driven upon in each case, a determining apparatus for determining the objective lateral freedom of movement of the vehicle in the lane, a specifying device for specifying a desired range of the distance of the vehicle from one boundary by the objective lateral freedom of movement, and an adaption device for adapting a parameter representative of the assessed attentiveness of the driver when the distance of the vehicle from one boundary leaves the desired range.

The measuring device for measuring the distance can comprise at least one camera and an image processing system. Depending on the placement on the vehicle and orientation, such a camera can detect a single or both lane boundaries in each case. The determining device for determining the objective lateral freedom of movement, for specifying the desired range and for adapting the parameter are expediently implemented on an onboard computer of the motor vehicle.

A computer program product is also provided with program code means that enable a computer to execute the method described above.

### BRIEF DESCRIPTION OF THE DRAWINGS

The present invention will hereinafter be described in conjunction with the following drawing figures, wherein like numerals denote like elements, and:

FIG. 1 shows a schematic view of an application situation of the method according to an embodiment; and

FIG. 2 shows a flow diagram of a method executed in an onboard computer of the vehicle from FIG. 1 for assessing the driver attentiveness according to a first embodiment of the method.

### DETAILED DESCRIPTION

The following detailed description is merely exemplary in nature and is not intended to limit application and uses. Furthermore, there is no intention to be bound by any theory presented in the preceding background or summary or the following detailed description.

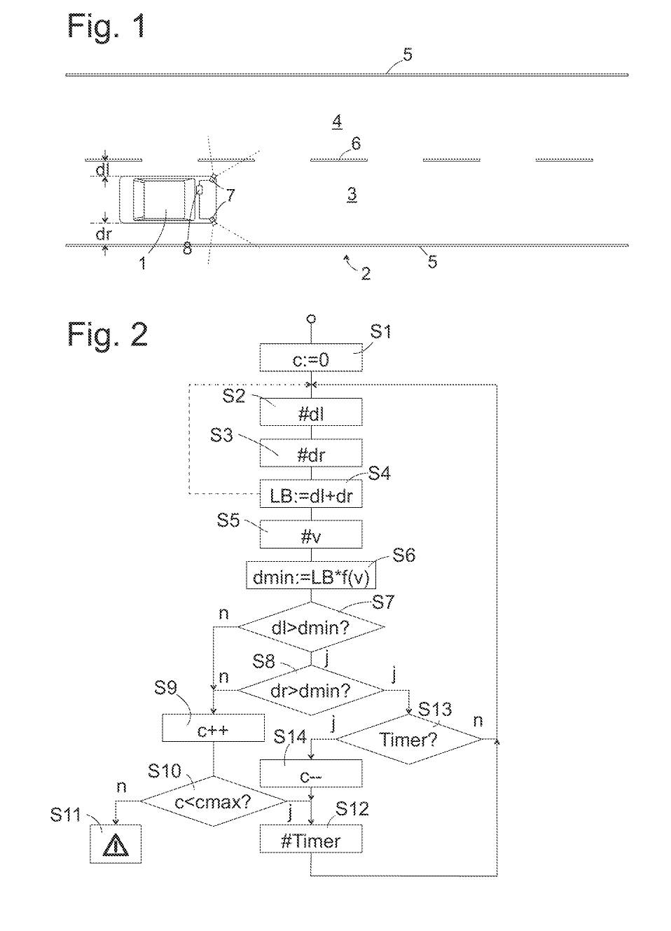

FIG. 1 shows in a schematic plan view a motor vehicle 1 traveling on a road 2. Two lanes 3, 4 of the road 2 are each marked by a continuous outer boundary line 5 and a broken center strip 6. The vehicle 1 has two cameras 7 aligned obliquely forward in the direction of travel for detecting the boundary line 5 adjacent to lane 3 of the vehicle 1 and the center strip 6. It would also be feasible to attach a single camera centrally on the vehicle in order to image both the boundary line 5 and the center strip 6 in a single image of this camera.

An onboard computer 8 of the vehicle is programmed to identify the center strip 6 or the boundary line 5 of the lane 3 in the images of the camera 7 using methods of pattern recognition known per se. Using the known alignment of the camera 7 relative to the lane longitudinal direction and the position of the detected boundary line 5 or the center strip 6 in the delivered images, the onboard computer 8 calculates the distance dl between the left flank of the vehicle 1 and the center strip 6 or the distance dr between the right flank of the vehicle and the boundary line 5. The sum of the two distances corresponds to the objective lateral freedom of movement of the vehicle, i.e., the extent by which the position of the vehicle can vary transversely to the longitudinal direction of the lane 3 without the vehicle going over the boundary lines 5, 6 of the lane 3.

The operating mode of the onboard computer 8 is explained in detail hereinafter with reference to the flow diagram of FIG. 2. In a step S1, on starting a journey, an internal counter c is set to a standard value, in the case considered here, to zero. In steps S2 to S4 the distances dl and dr of the vehicle from the center strip 6 and the boundary line 5 are measured and the objective lateral freedom of movement LB is calculated as the sum of the distances dl, dr.

If one of the two measurements does not yield a usable result for dl or dr, for example, because no line of the center strip 6 applied to the lane with interruptions or no sufficiently long piece is contained in the image studied of the left camera 7, because the boundary line 5 suddenly ends or cannot be identified on account of contamination, a measured value of dl or dr obtained in an earlier iteration of the method is used at least during a predefined time interval or over a predefined path length. If after a predefined time interval or the predefined path length, one of the distances dl, dr still cannot be determined, the method terminates and a method explained at a later point replaces this.

If, instead of the two sideways aligned cameras 7, a single camera is provided for detecting the center strip 6 and the boundary line 5 in respectively the same image, it can be computationally simpler to calculate respectively only one of the distances dl, dr and the width of the lane 3, i.e. the distance between center strip 6 and boundary line 5, from an image delivered by this camera and calculate the objective lateral freedom of movement by subtracting the known width of the vehicle 1 from the lane width.

The speed v of the vehicle is determined in step S5. In step S6 a minimum distance dmin that the vehicle 1 should maintain from the edges of the lane 3 is calculated as the product of the objective lateral freedom of movement LB with a function f(v) of the speed v. The function f(v) is a monotonically increasing function of the speed v, whose value is everywhere less than ½ and preferably less than ¼. Step S7 compares the measured distance dl with dmin. If dl is not larger than dmin, i.e., of the distance dl if the vehicle 1 from the center strip 6 is smaller than dmin, the method branches to step S9, where the counter c is incremented. Otherwise the method goes over to step S8 where a corresponding comparison is also made for dr. Here also the method branches to step S9 if dr is not greater than dmin.

Step S9 is followed by step S10 in which it is checked whether the counter c has reached a permissible maximum value cmax or not. If yes, the method ends with step S11 in which an optical, acoustic or haptic warning signal is generated in order to make the driver aware of his inadequate concentration and cause him to take a break from driving. If the maximum value cmax is not reached, the method branches to step S12 in which a timer is started and then returns to step S2, whereby another iteration of the method begins.

In the second and every successive execution of step S4, the value of the objective lateral freedom of movement LB thereby obtained is compared with that obtained in the previous iteration. If there is a significant deviation between the two values, i.e. if the difference between them exceeds a predefined fraction of dmin, this indicates a change in the width of the lane 3 which may necessitate steering maneuvers of the driver in order to align the vehicle again in the desired manner on the lane 3. In this case, the execution of the method is interrupted for a few seconds before it is taken up again in step S2.

If it is established in step S8 that the distance dr is greater than dmin, the vehicle is therefore correctly aligned in the lane 3, the method goes over to step S13 in which it is checked whether the timer started in step S12 has expired. If not, the method returns directly to step S2. If yes, and if the counter c is non-zero, it is decremented in step S14 and then the timer is started again (S12) before the method returns to step S2.

If both distances dl, dr are greater than dmin, this is equivalent to the statement that one of these two distances is located in a desired range [dmin, DL-dmin] As long as this desired range is not departed from, the counter c remains at zero. If the desired range is frequently departed from, the counter c increases above cmax in the course of time and the warning signal is triggered. If the distance dl or dr departs only very rarely from the desired range, the counter c can again return to zero in the course of time and no warning signal is generated even on a long journey.

In order to take account of the fact that the driver's ability to concentrate naturally diminishes in the course of time and after traveling for several hours, a rest period is fundamentally indicated, the decrementing of the counter c can be omitted or the run time of the timer after which the counter c is decremented increases with the travel time in order to increase the probability of a warning being generated after a long travel time.

In the case discussed above, that both distance measurement values dl, dr cannot be measured over a longer time interval, the onboard computer 8 determines dmin merely depending on the vehicle speed and of the comparison steps S7 and S8, only executes that for which the current distance measured value, dl or dr, exists. An incrementing or decrementing of the counter c can then take place under otherwise the same conditions as explained above with reference to steps S9 to S14.

While at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

What is claimed is:

1. A method for assessing an attentiveness of a driver of a motor vehicle traveling in a lane provided with boundaries on both sides, comprising:
measuring a distance of the motor vehicle from one of the boundaries;
determining an objective lateral freedom of movement of the motor vehicle in the lane;
specifying a desired range of the distance of the motor vehicle from one boundary with the objective lateral freedom of movement; and
adapting a parameter representative of the attentiveness of the driver when the distance of the motor vehicle from one of the boundaries leaves the desired range.

2. The method according to claim 1, wherein a width of the desired range is a fraction of the objective lateral freedom of movement dependent on vehicle speed.

3. The method according to claim 1, wherein determining the objective lateral freedom of movement of the motor vehicle in the lane, comprises:
measuring the distance of the motor vehicle from the other boundary; and
determining the objective lateral freedom of movement with a sum of distances.

4. The method according to claim 1, wherein determining the objective lateral freedom of movement of the motor vehicle in the lane, comprises:
measuring the distance between two boundaries; and
determining the objective lateral freedom of movement with a difference between the distance and a width of the motor vehicle.

5. The method according to claim 1, further comprising:
periodically repeating determining the objective lateral freedom of movement of the motor vehicle in the lane; and
suspending the determining the objective lateral freedom of movement of the motor vehicle in the lane if a change in the objective lateral freedom of movement is detected.

6. The method according to claim 1,
wherein the parameter is a numerical value, and
wherein adapting the parameter representative of the attentiveness of the driver when the distance of the motor vehicle from one of the boundaries leaves the desired range comprises increasing a deviation of the numerical value from a standard value, and
further comprising generating a warning when the deviation exceeds a limiting value.

7. The method according to claim 6, further comprising decreasing the deviation of the numerical value from the standard value when a predefined time span has elapsed.

8. A driver assistance system for assessing an attentiveness of a driver of a motor vehicle traveling in a lane provided with boundaries on both sides, comprising:
a measuring device configured to measure a distance of the motor vehicle from at least one of the boundaries;
a determining device configured to determine an objective lateral freedom of movement of the motor vehicle in the lane;
a specifying device configured to specify a desired range of the distance of the motor vehicle from one of the boundaries with the objective lateral freedom of movement;
an adapting device configured to adapt a parameter representative of the attentiveness of the driver when the distance of the motor vehicle from one of the boundaries leaves the desired range.

9. The driver assistance system according to claim 8, wherein the measuring device comprises at least one camera and an image processing system.

10. The driver assistance system according to claim 8, wherein the determining device is an onboard computer for the motor vehicle.

11. A computer readable medium embodying a computer program product, said computer program product comprising:
an assessing program for assessing an attentiveness of a driver of a motor vehicle traveling in a lane provided with boundaries on both sides, the assessing program is configured to:
measure a distance of the motor vehicle from one of the boundaries;
determine an objective lateral freedom of movement of the motor vehicle in the lane;
specify a desired range of the distance of the motor vehicle from one boundary with the objective lateral freedom of movement; and
adapt a parameter representative of the attentiveness of the driver when the distance of the motor vehicle from one of the boundaries leaves the desired range.

12. The computer readable medium embodying the computer program product according to claim 11, wherein a width of the desired range is a fraction of the objective lateral freedom of movement dependent on vehicle speed.

13. The computer readable medium embodying the computer program product according to claim 11, wherein the assessing program is configured to determine the objective lateral freedom of movement of the motor vehicle in the lane with a measurement of the distance of the motor vehicle from the other boundary, and the assessing program further configured to determine the objective lateral freedom of movement with a sum of distances.

14. The computer readable medium embodying the computer program product according to claim 11, wherein the assessing program is configured to determine the objective lateral freedom of movement of the motor vehicle in the lane with a measurement of the distance between two boundaries, and further configured to determine the objective lateral freedom of movement with a difference between the distance and a width of the motor vehicle.

15. The computer readable medium embodying the computer program product according to claim 11, the assessing program further configured to:
periodically repeat determining the objective lateral freedom of movement of the motor vehicle in the lane; and
suspend the determining the objective lateral freedom of movement of the motor vehicle in the lane if a change in the objective lateral freedom of movement is detected.

16. The computer readable medium embodying the computer program product according to claim 11,
wherein the parameter is a numerical value, and
wherein adapting the parameter representative of the attentiveness of the driver when the distance of the motor vehicle from one of the boundaries leaves the desired range comprises increasing a deviation of the numerical value from a standard value, and
wherein the assessing program is further configured to generate a warning when the deviation exceeds a limiting value.

17. The computer readable medium embodying the computer program product according to claim 16, that the assessing program is further configured to decrease the deviation of the numerical value from the standard value when a predefined time span has elapsed.
